(19) United States
(12) Patent Application Publication
(10) Pub. No.: US 2026/0287790 A1
(43) Pub. Date: Sep. 24, 2026

(54) MULTILAYER OPTICAL FILMS FOR LIDAR SYSTEMS

(71) Applicant: 3M INNOVATIVE PROPERTIES COMPANY, St. Paul, MN (US)

(72) Inventors: Lin Zhao, Woodbury, MN (US); John A. Wheatley, Stillwater, MN (US); Raghunath Padiyath, Woodbury, MN (US); Gilles J. Benoit, Minneapolis, MN (US); Stephen P. Maki, North St. Paul, MN (US)

(21) Appl. No.: 18/974,086

(22) PCT Filed: Jun. 7, 2023
(86) PCT No.: PCT/IB2023/055895

§ 371 Date: Dec. 9, 2024

Related U.S. Application Data
(60) Provisional application No. 63/353,680, filed on Jun. 20, 2022.

(51) Int. Cl. G02B 1/10; G01S 7/481; G01S 17/88

(52) U.S. Cl. CPC G02B 1/10; G01S 7/4811; G01S 17/88

(57) ABSTRACT

An integral optical film includes a plurality of at least first through third microlayers having different compositions. Each of the microlayers has an average thickness of less than about 500 nm. For an incident light, for at least one polarization state, a visible wavelength range, an infrared wavelength range that is at least 10 nm wide, a first incident angle range extending from about zero degree to about 20 degrees, and a second incident angle range extending from about 45 degrees to about 75 degrees, the optical film has: for the visible wavelength range, an average optical transmittance of greater than about 45% for each of the first and second incident angle ranges; and for the infrared wavelength range, an average optical transmittance of less than about 20% for the first incident angle range and an average optical transmittance of greater than about 45% for the second incident angle range.

### TECHNICAL FIELD

The disclosure generally relates to optical films and optical sensing systems, specifically to multilayer optical films configured to be incorporated in a window and optically transparent to Light Detection and Ranging (LiDAR).

### BACKGROUND

Automobiles are increasingly becoming self-driven. For instance, newer vehicles include features such as adaptive cruise control and parking assist systems that allow cars to steer themselves into parking spaces. Attempts are being made to create almost fully autonomous vehicles that can navigate with nearly no direct human input. Information and data on the surrounding of the self-driven vehicles are obtained from vehicle-external sources using sensing systems such as LiDAR and other near-infrared (NIR) sensors. Such sources external to the vehicle may include sensors connected to preceding and oncoming vehicles, pedestrians, cyclists, etc., and also sensors mounted on structures such as traffic lights, bridges, etc. The sensing systems may be configured to be installed outside or inside the vehicle. Sensing systems provided inside a cabin of the vehicle shield the sensors from being exposed to environmental conditions, including inclement weather, etc.

### SUMMARY

Some aspects of the disclosure relate to an integral optical film including a plurality of first optical repeat units numbering at least 10 in total disposed on, and separated by at least one spacer layer from, a plurality of second optical repeat units numbering at least 10 in total. Each of the first optical repeat units has at least microlayers A1 and B1 having different compositions. Each of the second optical repeat units has at least microlayers A2, B2 and C2 having different compositions. At least one of the microlayers A1 and B2 has a different composition than at least one of the microlayers A2, B2 and C2. Each of the microlayers in the first and second optical repeat units has an average thickness of less than about 500 nm. Each of the at least one spacer layer has an average thickness of greater than about 500 nm. For an incident light, for at least one polarization state, a visible wavelength range extending from about 420 nm to about 680 nm, an infrared wavelength range that is at least 10 nm wide and is within 750-1000 nm, a first incident angle range extending from about zero degree to about 20 degrees, and a second incident angle range extending from about 45 degrees to about 75 degrees, the optical film has: for the visible wavelength range, an average optical transmittance of greater than about 45% for each of the first and second incident angle ranges; and for the infrared wavelength range, an average optical transmittance of less than about 20% for the first incident angle range and an average optical transmittance of greater than about 45% for the second incident angle range. The integral optical film has an integral construction.

Some other aspects of the disclosure relate to an integral optical film including a plurality of at least first through third microlayers having different compositions and numbering at least 20 in total. Each of the at least first through third microlayers has an average thickness of less than about 500 nm. For an incident light, for at least one polarization state, a first incident angle range extending from about zero degree to at least about 40 degrees, and a normalized solar spectrum with an air mass of 1.5 and normalized across a solar wavelength range that includes at least a visible wavelength extending from about 420 nm to about 680 nm and a first infrared wavelength range that is at least 50 nm wide and is within 800-2500 nm, the normalized solar spectrum has average relative intensities Sv and Si1 in the respective visible and first infrared wavelength ranges and the integral optical film has average optical transmittances Tv and Ti1 in the respective visible and first infrared wavelength ranges, where Sv>Si1≥0.2, Tv/Ti1≥1.4.

Some other aspects of the disclosure relate to an integral optical film including a plurality of at least first through third microlayers having different compositions and numbering at least 20 in total. Each of the at least first through third microlayers has an average thickness of less than about 500 nm. For an incident light, for at least one polarization state, a first incident angle range extending from about zero degree to at least about 40 degrees, and a normalized solar spectrum with an air mass of 1.5 and normalized across a solar wavelength range that includes a visible wavelength range extending from about 420 nm to about 680 nm and at least non-overlapping first, second and third infrared wavelength ranges that are within 800-2500 nm, have respective average relative intensities Si1, Si2 and Si3, and are at least 40 nm wide each, the normalized solar spectrum and the integral optical film have respective average relative intensities Sv, Si1, Si2 and Si3 and average optical transmittances Tv, Ti1, Ti2 and Ti3 in the respective visible and the first through the third infrared wavelength ranges, where Sv>Si1>Si2>Si3≥0.1, each of Tv/Ti1 and Tv/Ti3 greater than 1.4, Tv/Ti2≤2.5.

Some aspects of the disclosure relate to an integral optical film including a plurality of at least first through third microlayers having different compositions and numbering at least 20 in total. Each of the at least first through third microlayers has an average thickness of less than about 500 nm. For an incident light incident on the integral optical film at a first incident angle of less than about 10 degrees and for at least one polarization state, an optical transmittance of the integral optical film versus wavelength includes a first transmission band including at least a majority of wavelengths in a visible wavelength range extending from about 420 nm to about 680 nm. A first transmission stop band is disposed between the first transmission band and a second transmission band and includes at least a majority of wavelengths in a first infrared wavelength range extending from about 700 nm to about 950 nm. A second infrared transmission stop band is disposed adjacent the second transmission band opposite the first transmission stop band and includes at least some wavelengths in a second infrared wavelength range extending from about 1200 nm to about 1300 nm. For visible and second infrared wavelength ranges, the integral optical film has respective average optical transmissions Tv and Ti for the first incident angle, and respective average optical transmissions Tv′ and Ti′ for a second incident angle of greater than about 30 degrees, where Tv and Tv′ are within 30% of each other, and Ti is greater than Ti′ by at least a factor of 1.3.

Some aspects relate to optical constructions including integral optical films of one or more embodiments of the disclosure bonded to at least one bonding layer.

Other aspects of the disclosure relate to a windshield of a vehicle including an integral optical film of one or more embodiments of the disclosure disposed between, and bonded to, first and second substrates.

Some other aspects of the disclosure relate to an optical sensing system including a windshield of a vehicle and a transceiver including at least one of a transmitter and a receiver and configured to at least one of emit and receive a first light toward an object through the windshield along a propagation direction making a first angle in air with a normal to the windshield. The first angle is greater than about 20 degrees.

### BRIEF DESCRIPTION OF DRAWINGS

The various aspects of the disclosure will be discussed in greater detail with reference to the accompanying figures where,

FIG. 1 schematically shows an integral multilayer optical film according to some embodiments of the disclosure;

FIGS. 2-3 graphically show the transmission spectra of different optical film configurations at different wavelengths and incident angles;

FIG. 4 graphically shows the normalized solar intensity and the transmission spectra of different optical film configurations at different wavelengths over an incident angle range of 0-85 degrees;

FIGS. 5-6 schematically show a windshield of a vehicle including an integral optical film according to one or more embodiments of the disclosure;

FIG. 7 schematically shows an optical sensing system according to some embodiments of the disclosure;

FIG. 8 graphically shows the transmission spectra of an optical film at different wavelengths and incident angles according to some embodiments; and

FIGS. 9A-9D, 10A-10D, 11-14 graphically represent the number of layers and layer thickness of different microlayer stacks having different compositions.

The figures are not necessarily to scale. Like numbers used in the figures refer to like components. However, it will be understood that the use of a number to refer to a component in a given figure is not intended to limit the component in another figure labelled with the same number.

### DETAILED DESCRIPTION OF ILLUSTRATIVE EMBODIMENTS

In the following description, reference is made to the accompanying drawings that form a part hereof and in which various embodiments are shown by way of illustration. It is to be understood that other embodiments are contemplated and may be made without departing from the scope or spirit of the present description. The following detailed description, therefore, is not to be taken in a limiting sense.

Active driving assistance systems such as adaptive cruise control and land keeping assist have become common in recent vehicles. Vehicles being equipped with more advanced self-driving features are also being developed in recent years. Therefore, the need to integrate more sensors in a vehicle will continue to grow. Particularly, LiDAR systems have been adopted by many automotive manufactures to enable driver-assistance and autonomous-driving features. In most prototype vehicles, the LiDAR system is mounted externally. But there are many advantages to move the LiDAR unit inside the vehicle behind the windshield for aesthetic and practical reasons such as protection from inclement weather.

One of the challenges for LiDAR mounted inside the windshield is that automotive windshield glass is not transparent to LiDAR wavelengths because it is designed to reflect and/or absorb in the LiDAR wavelengths common with that for solar heat rejection. One of the solutions to this problem is to create a cut-out in the automotive windshield. Another is to use an IR transparent glass. Creating a physical cut-out is a major barrier that requires significant change and adjustment in the windshield manufacturing process. In either of the above-mentioned, there will be no solar heat rejection in the LiDAR compartment, which can lead to excessive heat and damage to the sensitive electronics. Embodiments described herein address these and other challenges.

Embodiments of the present disclosure describe multilayer optical films (MOF) that are transparent to mainstream LiDAR operation wavelengths (e.g., 905 nm) while maintaining solar heat rejection performance for automotive windshields. The embodiments disclosed herein eliminates the need of a physical cut-out in the windshield and allows solar protection for both the cabin and the LiDAR compartment.

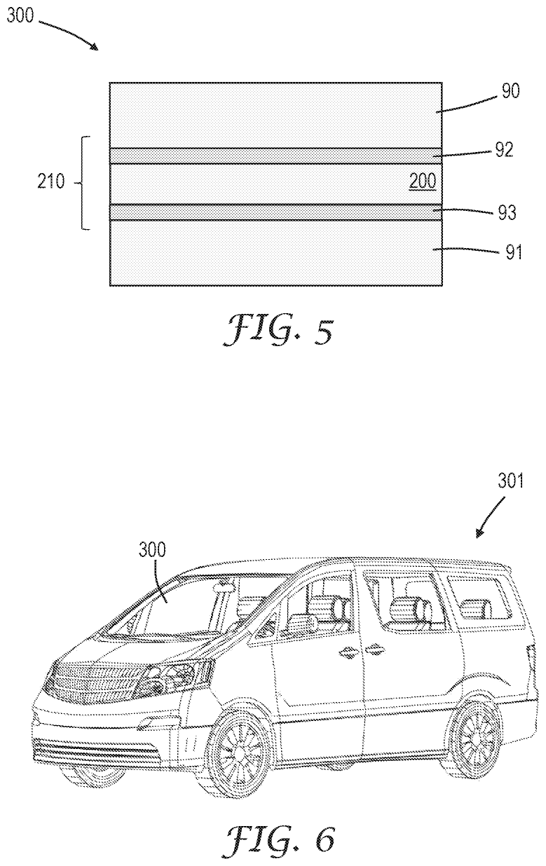

As shown in FIGS. 5 and 6, a vehicle (301) may include a window (300) configured to be an optically transparent window. For instance, the window (300) may be a front windshield of the vehicle (301). An integral optical construction (210) including an integral optical film (200) according to one or more embodiments of the disclosure may be configured to be incorporated in the window (300).

In some embodiments, the integral optical film (200) may be embedded in the window. In other embodiments, the integral optical film (210) may be bonded to a first bonding layer (92) configured to bond to a first substrate (90) of the window (300). The first substrate (90), for instance, may include glass. The integral optical film (200) may be substantially coextensive in length and width with the first bonding layer (92). In other aspects, the integral optical film (200) may be further bonded to a second bonding layer (93), opposite the first bonding layer (92), such that the integral optical film (200) is disposed between and bonded to the first (92) and second (93) bonding layers. The second bonding layer (93) may be configured to bond to a second substrate (91) of the window (300). The second substrate (91), for instance, may include glass. The integral optical film (200) may be substantially coextensive in length and width with the second bonding layer (93).

In some aspects, at least one of the first (92) and second (93) bonding layers may include one or more of a polyvinyl butyral (PVB), a pressure sensitive adhesive (PSA), an ethylene vinyl acetate (EVA), a polyolefin, and a polyurethane. In some aspects, for an infrared wavelength range (e.g., 885-925 nm), each of the first (92) and second (93) bonding layers may have an average optical transmittance of greater than about 60%, or greater than about 70%, or greater than about 80%, or greater than about 90% for each of a first incident angle range extending from about 0-20 degrees and a second incident angle range extending from about 45-75 degrees.

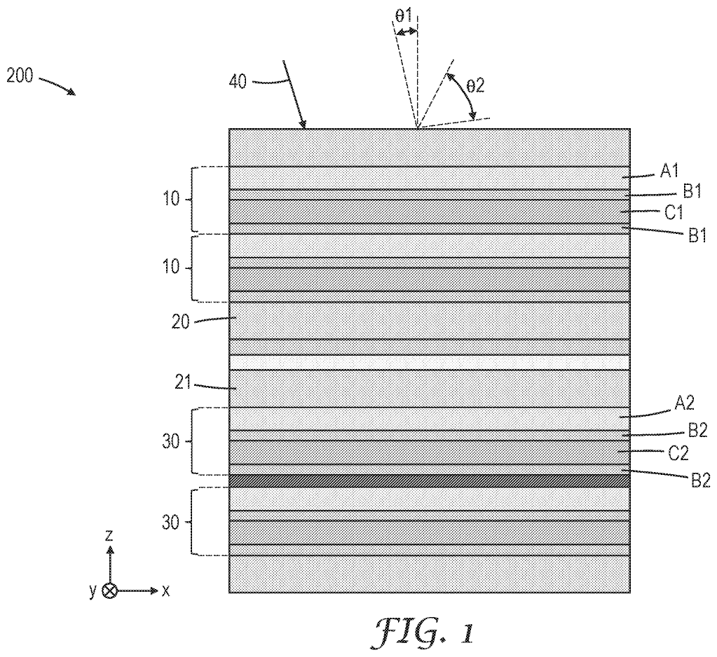

The integral optical film (200) has an integral construction. The construction of the integral optical film (200) according to some embodiments will be described with reference to FIG. 1.

The integral optical film (200) includes a plurality of at least first through third microlayers (A1, B1, C1, A2, B2, C2) numbering at least 20, or 50, or 100, or 150, or 200, or 250, or 300, or 350, or 400, or 450, or 500 in total. In some embodiments, the integral optical film (200) may include pluralities of first and second optical repeat units (10, 30). Each of a plurality of first optical repeat units (10) may include at least microlayers A1 and B1 and each of a plurality of second optical repeat units (30) may include at least microlayers A2, B2 and C2. The first optical repeat units (10) may be disposed on the second optical repeat units (30).

In some aspects, the first optical repeat units (10) may be separated from the second optical repeat units (30) by at least one spacer layer (20, 21). The spacer layers (20, 21) may have an average thickness of greater than about 500 nm, or greater than about 550 nm, or greater than about 600 nm, or greater than about 650 nm, or greater than about 700 nm, or greater than about 800 nm, or greater than about 900 nm, or greater than about 1000 nm.

In some aspects, the plurality of first optical repeat units (10) may number at least 10 or 15, or 20, or 50, or 100, or 200, or 300, or 400, or 500 in total. The plurality of the second optical repeat units (30) may number at least 10, or 15, or 20, or 50, or 100, or 200, or 250, or 300 in total.

The microlayers A1, B1, C1, A2, B2, C2 may include different compositions. In some aspects, at least one of the microlayers A1 and B2 may have a different composition than at least one of the microlayers A2, B2 and C2. Each of the microlayers in the first and second optical repeat units (10, 30) may have an average thickness of less than about 500 nm or less than about 450 nm, or less than about 400 nm, or less than about 350 nm, or less than about 300 nm, or less than about 250 nm, or less than about 200 nm.

Different designs of the microlayer stacks (multilayer optical films (MOF)) are suggested that are transparent to visible and LiDAR signal while reflecting solar IR energy. The transparency window of the LiDAR signal is centered around 905 nm (+/−20 nm) for incident angles from at least about 40° to 85° accommodating typical windshield configurations and LiDAR scanning angles.

In some embodiments, the materials of the plurality of microlayers may have differing indices of refraction. For instance, the microlayers may have stacks including PET and co polymers of PMMA (coPMMA), or any other polymer having low refractive index, including copolyesters, fluorinated polymers or combinations thereof.

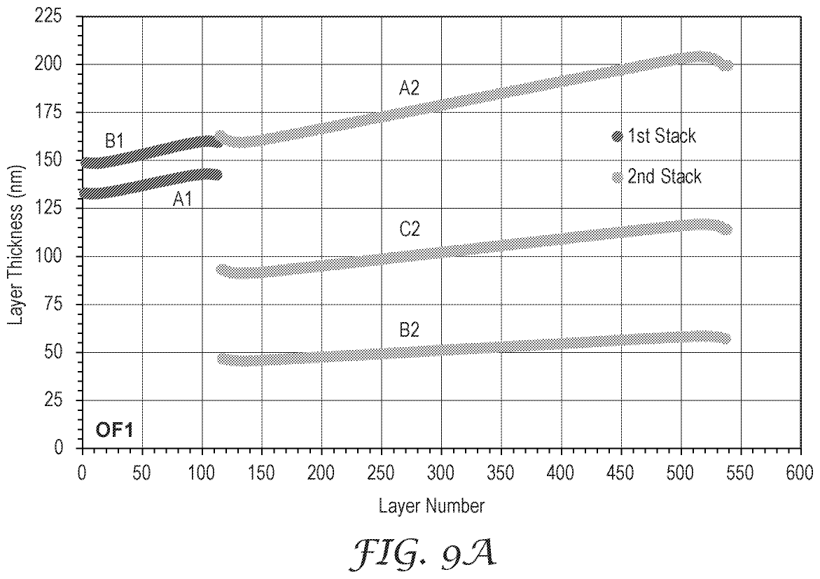

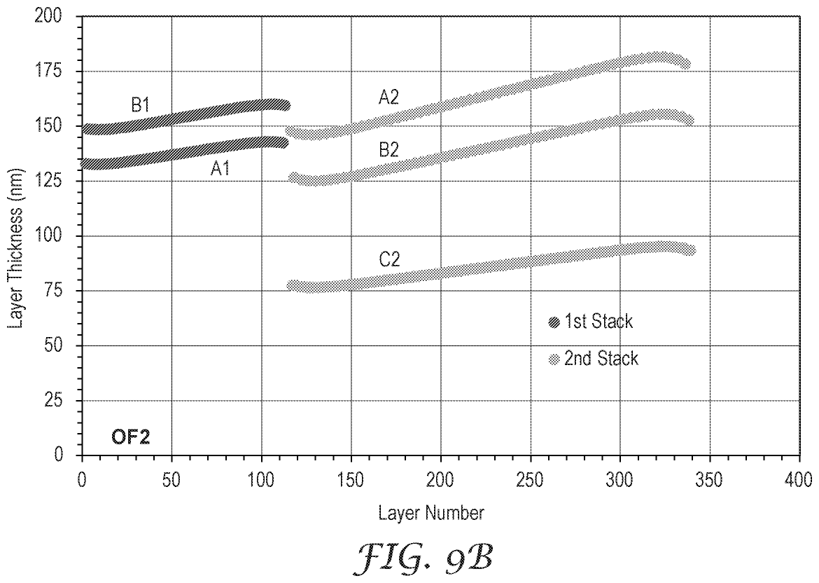

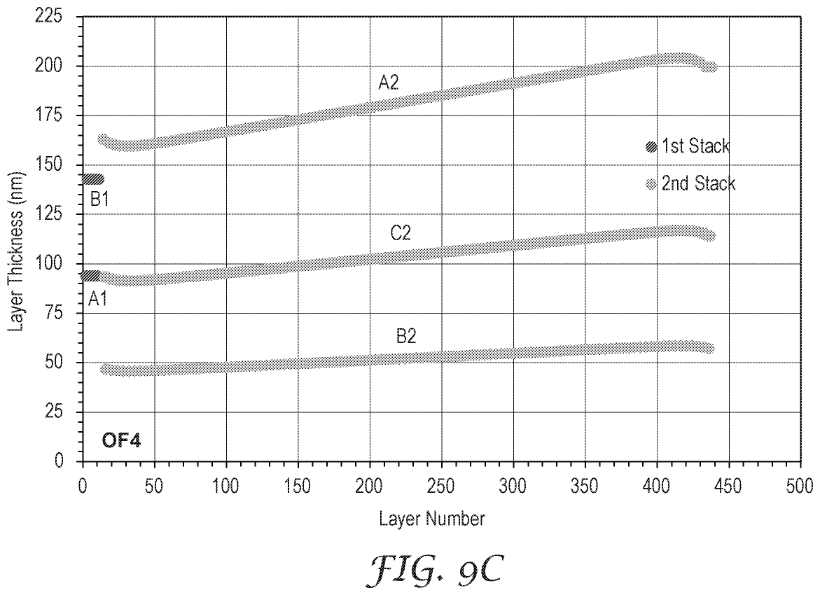

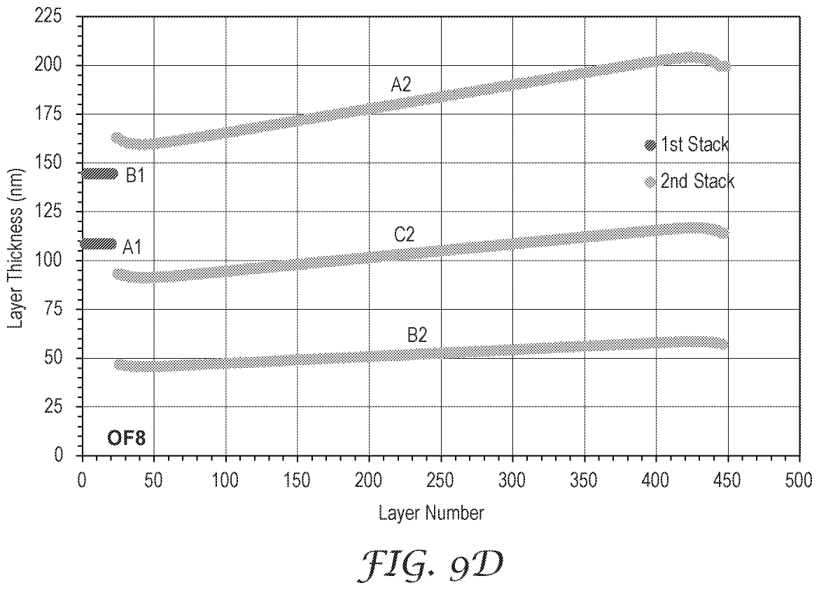

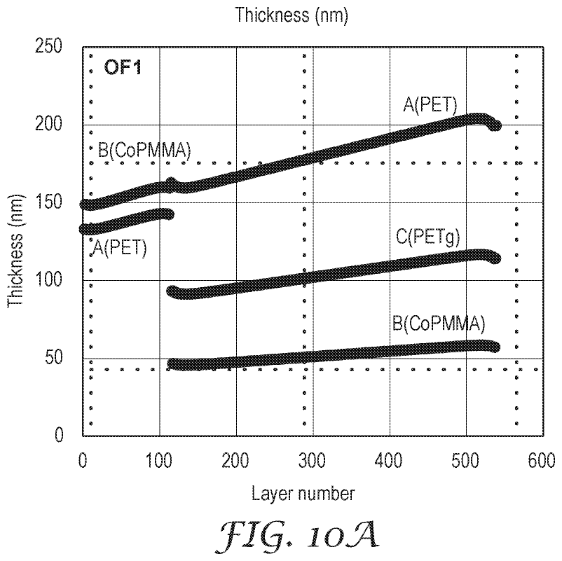

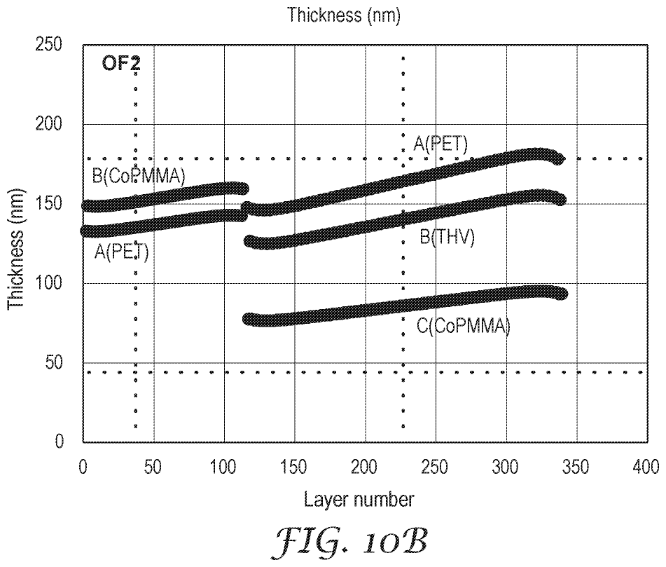

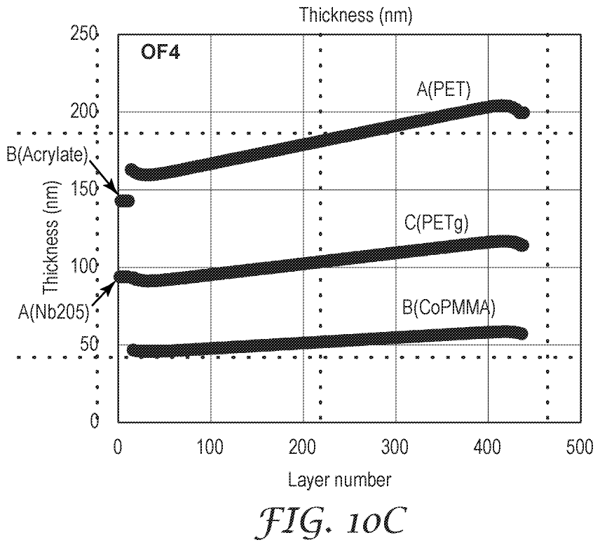

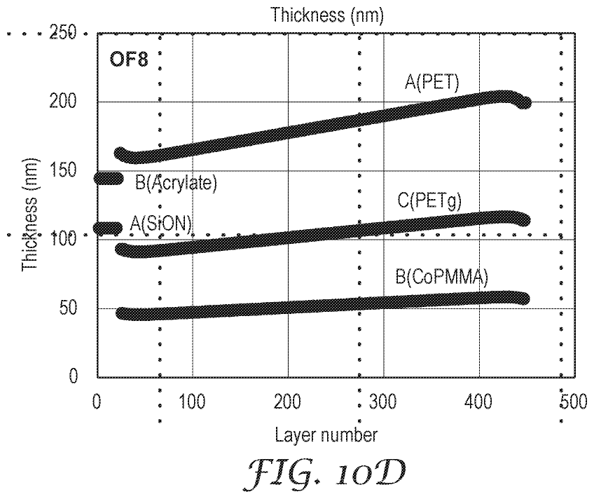

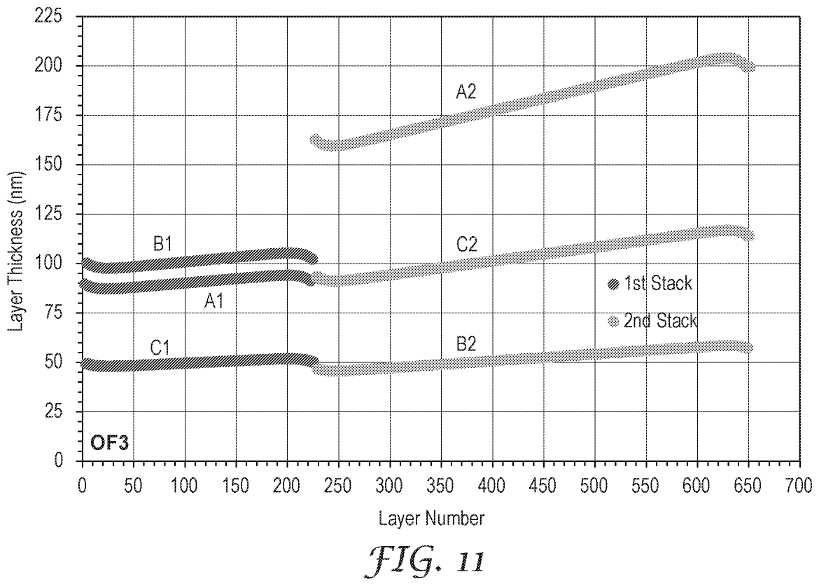

In one embodiment, as best shown in FIGS. 9A-9D and 10A-10D, the plurality of the at least first through third microlayers includes a plurality of alternating microlayers A1 and B1 numbering at least 5, or 10, or 15, or 20, or 50, or 100, or 200, or 300, or 400, or 500 in total disposed on a plurality of alternating microlayers A2, C2, B2 and C2 numbering at least 10, or 15, or 20, or 50, or 100, or 200, or 250, or 300, or 350, or 400 in total. The microlayers A1 and B1 may have different compositions and the microlayers A2, B2 and C2 may have different compositions. At least one of the microlayers A1 and B1 may have a different composition than at least one of the microlayers A2, B2 and C2. Each of the microlayers A1, B1, A2, B2 and C2 may have an average thickness of less than about 500 nm, or less than about 450 nm, or less than about 400 nm, or less than about 350 nm, or less than about 300 nm, or less than about 250 nm, or less than about 200 nm.

In one aspect, the microlayers A1 and A2 may have a same composition and the microlayers B1 and B2 have a same composition. For example, the MOF design as shown in FIGS. 9A and 10A may combine a quarter-wave A1-B1 MOF (for instance, polyethylene terephthalate (PET)-copolymer of polymethylmethacrylate (CoPMMA)) with a A2-B2-C2 MOF (for instance, PET-CoPMMA-glycol-modified PET (PETg)) to create two reflection bands in the NIR spectrum and opens a spectral window for the LiDAR wavelength. At least most of the microlayers A1 may be thinner than at least most of the microlayers A2, and at least most of the microlayers B1 may be thicker than at least most of the microlayers B2. In some instances, most of the microlayers A1 may be thinner than at least most of the microlayers B1. In some instances, at least most of the microlayers B2 may be thinner than at least most of the microlayers C2, and at least most of the microlayers C2 may be thinner than at least most of the microlayers A2. At least one spacer layer (20, 21) may be disposed between the plurality of the alternating microlayers A1-B1 and the plurality of the alternating microlayers A2-C2-B2-C2. Each of the at least one spacer layer having an average thickness of greater than about 500 nm, or 550 nm, or 600 nm, or 650 nm, or 700 nm, or 800 nm, or 900 nm, or 1000 nm.

In another aspect, the microlayers A1 and A2 may have a same composition and the microlayers B1 and C2 may have a same composition. For example, as shown in FIGS. 9B and 10B, the MOF design may combine a quarter-wave A1-B1 MOF (for instance, PET-CoPMMA) with a A2-C2-B2-C2 MOF (for instance, PET-CoPMMA-vinylidene fluoride (THV)-CoPMMA) to create two reflection bands in the NIR spectrum and opens a spectral window for the LiDAR wavelength. THV is available from 3M Company, St. Paul, MN under the brand Dyneon™. THV may be used as the low index material in the A2-C2-B2-C2 stack to leverage its low refractive index (n~1.37). In some instances, at least most of the microlayers A1 may be thinner than at least most of the microlayers A2, and at least most of the microlayers B1 may be thicker than at least most of the microlayers C2. In other instances, at least most of the microlayers A1 may be thinner than at least most of the microlayers B1. At least most of the microlayers B2 may be thinner than at least most of the microlayers A2, and at least most of the microlayers C2 may be thinner than at least most of the microlayers B2. At least one spacer layer (20, 21) may be disposed between the plurality of the alternating microlayers A1-B1 and the plurality of the alternating microlayers A2-C2-B2-C2.

In another aspect, the microlayers A1, A2, B1, B2 and C2 have different compositions. For instance, at least one of the microlayers A1 and microlayers B1 are inorganic layers. The microlayers A1 may include Nb2O5 or, in some instances, SiON. The microlayers B1 may include an acrylate. For example, as shown in FIGS. 9C and 10C, the MOF design may combine an inorganic quarter-wave A1-B1 stack (for instance, Nb2O5-Acrylate) with a A2-C2-B2-C2 MOF (for instance, PET-PETg-CoPMMa-PETg) to create two reflection bands in the NIR spectrum and opens a spectral window for the LiDAR wavelength.

In another example as shown in FIGS. 9D and 10D, the MOF design may combine an inorganic quarter-wave A1-B1 stack (for instance, SiON/Acrylate) with a A2-C2-B2-C2 MOF stack (for instance, PET-PETg-CoPMMA-PETg) to create two reflection bands in the NIR spectrum and open a spectral window for the LiDAR wavelength. The SiON (n~2.03) has a slightly lower index compared to Nb2O5 (n~2.33), which leads to a narrower intrinsic bandwidth. The narrower bandwidth helps manage the color artifact at high angles. In some cases, the alternating microlayers A1-B1 may number less than 50, or 45, or 40, or 35, or 35, or 20 in total, and the alternating microlayers A2-C2-B2-C2 may number at least 200, or 300, or 400, or 500, or 600, or 700, or 800, or 900, or 1000, or 1200 in total. At least most of the microlayers A1 may be thinner than at least most of the microlayers A2, and at least most of the microlayers B1 may be thicker than at least most of the microlayers B2. In some cases, most of the microlayers A1 may be thinner than most of the microlayers B1. In other cases, at least most of the microlayers B2 may be thinner than at least most of the microlayers C2, and at least most of the microlayers C2 may be thinner than at least most of the microlayers A2.

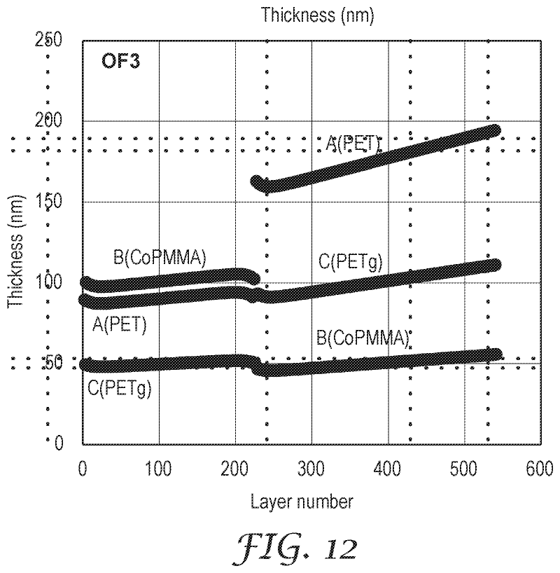

In one embodiment, as shown in FIG. 11, the plurality of the at least first through third microlayers includes a plurality of alternating microlayers A1-C1-B1-C1 numbering at least 50, or 100, or 150, or 200, or 250, or 300, or 350, or 400, or 450, or 500, or 550, or 600 in total disposed on a plurality of alternating microlayers A2-C2-B2-C2 numbering at least at least 200, or 300, or 400, or 500, or 600, or 700, or 800, or 900, or 1000, or 1200, or 1400, or 1600 in total. As shown in FIG. 12, the microlayers A1, B1 and C1 may have different compositions and the microlayers A2, B2 and C2 may have different compositions. In some aspects, at least one of the microlayer A1, B1 and C1 may have a different composition than at least one of the microlayers A2, B2 and C2. In some cases, the microlayers A1 and A2 may have a same composition, the microlayers B1 and B2 have a same composition, and the microlayers C1 and C2 have a same composition. For instance, the microlayers A1 and A2 may include PET, the microlayers B1 and B2 may include CoPMMA, and the microlayers C1 and C2 may include PETg. For example, the MOF design may include two A-C-B-C MOF stacks (for instance, PET-PETg-CoPMMA-PETg) to create two reflection bands in the NIR spectrum and opens a spectral window for the LiDAR wavelength.

Each of the microlayers A1, B1, C1, A2, B2 and C2 may have an average thickness of less than about 500 nm, or less than about 450 nm, or less than about 400 nm, or less than about 350 nm, or less than about 300 nm, or less than about 250 nm, or less than about 200 nm. At least most of the microlayers A1 may be thinner than at least most of the microlayers A2, at least most of the microlayers B1 may be thicker than at least most of the microlayers B2, and at least most of the microlayers C1 may be thinner than at least most of the microlayers C2. In some instances, most of the microlayers A1 may be thinner than most of the microlayers B1, and most of the microlayers C1 may be thinner than most of the microlayers A1. In other instances, at least most of the microlayers B2 may be thinner than at least most of the microlayers C2, and at least most of the microlayers C2 may be thinner than at least most of the microlayers A2. At least one spacer layer (20, 21) may be disposed between the plurality of the alternating microlayers A1, C1, B1 and C1 and the plurality of the alternating microlayers A2, C2, B2 and C2.

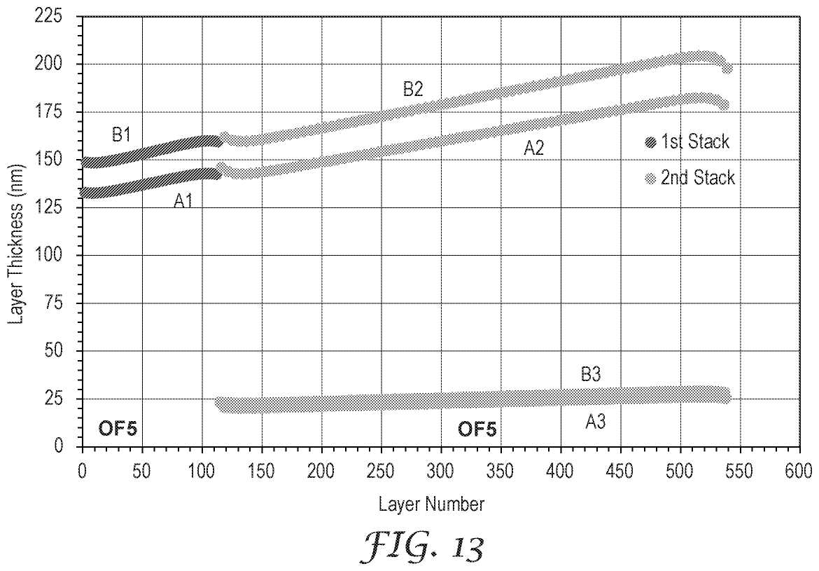

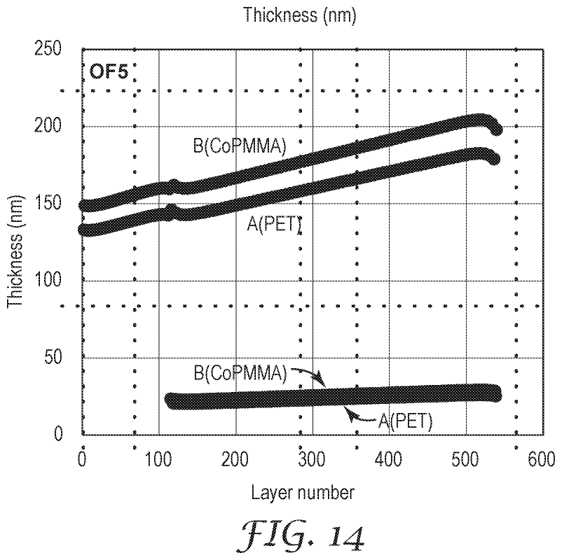

In one embodiment, as shown in FIG. 13, the plurality of the at least first through third microlayers may include a plurality of alternating microlayers A1 and B1 numbering at least 50, or 75, or 100, or 125, or 150, or 175, or 200 in total disposed on a plurality of alternating microlayers A2-B3-A3-B2-A3-B3 numbering at least 100, or 200, or 300, or 400, or 500, or 600 in total. The microlayers A1 and B1 may have different compositions. The microlayers A2 and A3 may have substantially a same composition and different thicknesses. The microlayers B2 and B3 may have substantially a same composition and different thicknesses. At least one of the microlayer A1 and B1 may have a different composition than at least one of the microlayers A2 and B2. As shown in FIG. 14, in some aspects, the microlayers A1 and A2 may have a same composition and the microlayers B1 and B2 may have a same composition. At least most of the microlayers A1 may be thinner than at least most of the microlayers B2, and at least most of the microlayers B1 may be thicker than at least most of the microlayers A3 and B3. For instance, the microlayers A1 and A2 may include PET, and the microlayers B1 and B2 may include CoPMMA. At least one spacer layer (20, 21) may be disposed between the plurality of the alternating microlayers A1-B1 and the plurality of the alternating microlayers A2-B3-A3-B2-A3-B3.

Each of the microlayers A1, B1, A2, B2, A3, B3 may have an average thickness of less than about 500 nm, or less than about 450, or less than about 400 nm, or less than about 350 nm, or less than about 300 nm, or less than about 250 nm, or less than about 200 nm. At least most of the microlayers A1 may be thinner than at least most of the microlayers B1. In some cases, at least most of the microlayers A3 may be thinner than at least most of the microlayers A2, and at least most of the microlayers B3 may be thinner than at least most of the microlayers B2.

Other designs of the optical film may include a metal/dielectric/metal (Ag/ITO/Ag) stack to create a broad reflection band in the NIR spectrum while maintaining a reasonable level of transmission at 905 nm for LiDAR operation. Some embodiments of the optical film design combines a quarter-wave AB MOF (PET/CoPMMA) with a 7-11 MOF (PET/CoPMMA) to create two reflection bands in the NIR spectrum and open a spectral window for the LiDAR wavelength. A 7-11 MOF refers to a layer structure where the high-index layers (H) and low-index layers (L) are arranged in a six-layer repeating unit-cell with their thickness ratio as HLHLHL=7:1:1:7:1:1. Multilayer optical films with such layer structures are described, for example, in Arends et al, U.S. Pat. No. 5,360,659.

To extend the reflection band into the infrared spectrum beyond 1200 nm, an ACBC and 7-11 MOF unit cell structure can be used to suppress higher order harmonics in the visible spectrum. In other embodiments, the optical film design may be a combination of a MOF-AB stack (PET/CoPMMA) with an inorganic 7-11 stack (SiON/Acrylate) to create two reflection bands in the NIR spectrum and open a spectral window for the LiDAR wavelength.

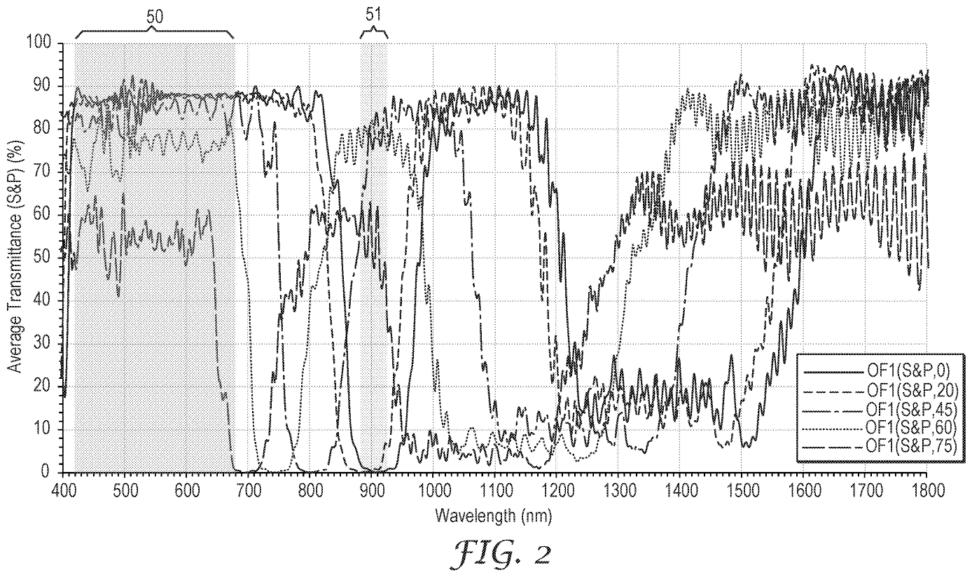

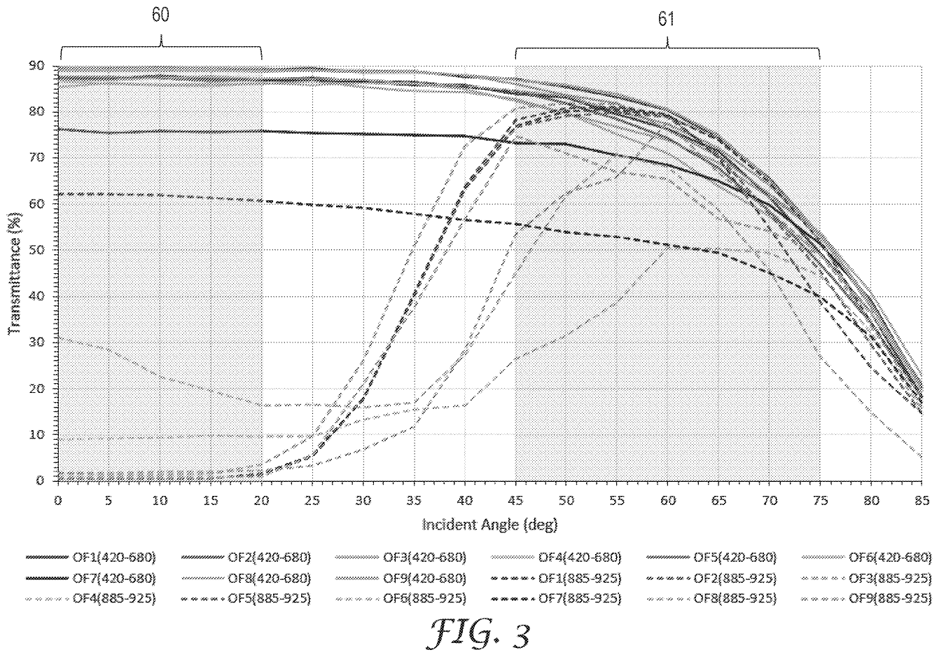

The average optical transmittances of the different optical film designs disclosed herein, in a visible wavelength range (50) extending from about 420 nm to about 680 nm, and in an infrared wavelength range (51), having a width of at least 10 nm, or 15 nm, or 20 nm, or 25 nm, or 30 nm, or 35 nm, or 40 nm and within 750-1000 nm, at first and second incident angle ranges (60, 61), are shown in FIGS. 2 and 3. The first incident angle range (60) may extend from about zero degree to about 20 degrees, and the second incident angle range (61) may extend from about 45 degrees to about 75 degrees.

In some aspects, for an incident light (40, FIG. 1), for at least one polarization state (x- & y-axes), and for each of the first and second incident angle ranges (60, 61), the average optical transmittance of the optical film may be greater than about 45%, or 50%, or 55%, or 60%, or 65%, or 70%, or 75%, or 80%, or 85% for the visible wavelength range (50).

In some aspects, for an incident light (40, FIG. 1), for at least one polarization state (x- & y-axes), the average optical transmittance of the optical film in the first incident angle range (60) may be less than about 20%, or 15%, or 10%, or 9%, or 8%, or 7%, or 6%, or 5%, or 4%, or 3%, or 2%, or, in some instances, less than about 1% for the infrared wavelength range (51).

In other aspects, for an incident light (40, FIG. 1), for at least one polarization state (x- & y-axes), the average optical transmittance of the optical film in the second incident angle range (61) may be greater than about 45%, or 50%, or 55%, or 60%, or 65%, or, in some instances, greater than about 70% for the infrared wavelength range (51).

In some cases, the infrared wavelength range may be within 800-950 nm. In some other cases, the infrared wavelength range may include one or more of 850 nm, 905 nm, and 940 nm.

Table 1 shows the optical transmittances of different optical film configurations (OF1, OF2 . . . OF9) in a visible wavelength range extending from about 420 nm to about 680 nm and at first incident angle range extending from about zero degree to about 20 degrees and a second incident angle range extending from about 45 degrees to about 75 degrees according to some embodiments of the disclosure.

TABLE 1

| Incident | | | | | | | | | |
|---|---|---|---|---|---|---|---|---|---|
| angles | | | | | | | | | |
| (°) | OF1 | OF2 | OF3 | OF4 | OF5 | OF6 | OF7 | OF8 | OF9 |
| 0-20 | 87.2 | 87.2 | 87.1 | 86.1 | 89.4 | 85.8 | 75.8 | 89.5 | 89.0 |
| 45-75 | 72.2 | 70.3 | 73.6 | 68.4 | 75.6 | 71.0 | 65.9 | 73.4 | 75.8 |

Table 2 shows the optical transmittances of different optical film configurations (OF1, OF2 . . . OF9) in an infrared wavelength range extending from about 885 nm to about 925 nm and at first incident angle range extending from about zero degree to about 20 degrees and a second incident angle range extending from about 45 degrees to about 75 degrees according to some embodiments of the disclosure.

TABLE 2

| Incident | | | | | | | | | |
|---|---|---|---|---|---|---|---|---|---|
| angles | | | | | | | | | |
| (°) | OF1 | OF2 | OF3 | OF4 | OF5 | OF6 | OF7 | OF8 | OF9 |
| 0-20 | 0.7 | 0.7 | 1.9 | 9.4 | 0.7 | 23.6 | 61.7 | 2.0 | 0.8 |
| 45-75 | 72.5 | 69.8 | 73.6 | 41.7 | 69.1 | 53.9 | 49.7 | 62.1 | 62.6 |

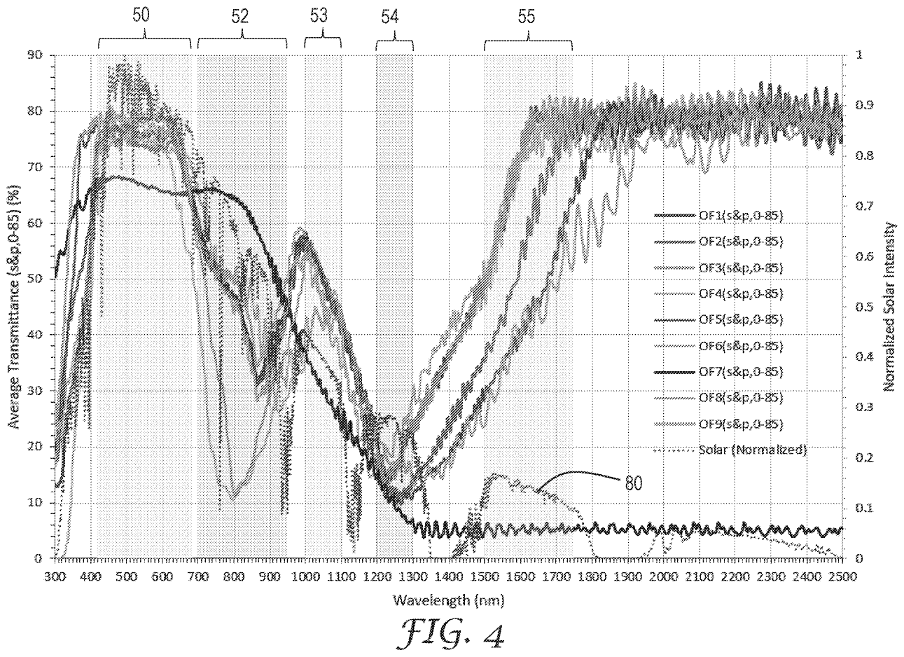

FIG. 4 shows the average relative intensities of a normalized solar spectrum (80) and the average optical transmittances of the different optical film designs at a first incident angle range extending from about zero degrees to at least about 40 degrees, or 45 degrees, or 50 degrees, or 55 degrees, or 60 degrees, or 65 degrees, or 70 degrees, or 75 degrees, or 80 degrees, or 85 degrees. The normalized solar spectrum (80) may have an air mass of 1.5 and may be normalized across a solar wavelength range that includes at least the visible wavelength (50) extending from about 420 nm to about 680 nm and a first infrared wavelength range (52) that may be at least 50 nm wide and within 800-2500 nm. In some instances, the first infrared wavelength range (52) may extend from about 700 nm to about 950 nm.

In some aspects, for an incident light (40, FIG. 1), and for at least one polarization state (x- & y-axes), the normalized solar spectrum (80) may have average relative intensities Sv and Si1 in the respective visible (50) and first infrared (52) wavelength ranges. In some cases, Sv>Si1≥0.2, or Sv>Si1≥0.25, or Sv>Si1≥0.3, or Sv>Si1≥0.35, or Sv>Si1≥0.4, or Sv>Si1≥0.45, or Sv>Si1≥0.5, or Sv>Si1≥0.55, or Sv>Si1≥0.55.

In some instances, the average relative intensities Sv and Si1 are such that 1≤Sv/Si1≤2. In some instances, the average relative intensity, Sv, in the visible wavelength range (50) may be greater than the average relative intensity, Si1, in the first infrared wavelength range (52) by at least 0.05, or by at least 0.1, or by at least 0.15, or by at least 0.2, or by at least 0.25, or by at least 0.3.

In some aspects, for an incident light (40, FIG. 1), and for at least one polarization state (x- & y-axes), the integral optical film may have average optical transmittances Tv and Ti1 in the respective visible (50) and first infrared (52) wavelength ranges. In some cases, Tv/Ti1≥1.4, or Tv/Ti1≥1.5, or Tv/Ti1≥1.75, or Tv/Ti1≥2, or Tv/Ti1≥2.25, or Tv/Ti1≥2.5, or Tv/Ti1≥2.75, or Tv/Ti1≥3, or Tv/Ti1≥3.25, or Tv/Ti1≥3.5.

In some instances, the average optical transmittance Tv of the integral optical film in the visible wavelength range (50) may be such that Tv≥50%, or Tv≥55%, or Tv≥60%, or Tv≥65%, or Tv≥70%. In some instances, the average optical transmittance Ti1 of the integral optical film in the first infrared wavelength range (52) may be such that Ti1≤30%, or Ti1≤25%, or Ti1≤20%.

In some embodiments, the normalized solar spectrum (80) may further include a second infrared wavelength range (53) that may be at least 50 nm wide and within 800-2500 nm. The first infrared wavelength range (52) may be disposed between the visible (50) and second (53) infrared wavelength ranges. In some instances, the second infrared wavelength range (53) may extend from about 1000 nm to about 1100 nm as shown in FIG. 4.

The normalized solar spectrum (80) may have an average relative intensity Si2 in the second infrared wavelength range (53) such that Si2≤Si1. For the incident light, the at least one polarization state, and the first incident angle range, the integral optical film may have an average optical transmittance Ti2 in the second infrared wavelength range (53). In some aspects, Tv/Ti2≤2.5, or Tv/Ti2≤2.25, or Tv/Ti2≤2, or Tv/Ti2≤1.75.

In some other embodiments, the normalized solar spectrum (80) may further include a third infrared wavelength range (54) that may be at least 50 nm wide and within 800-2500 nm. The second infrared wavelength range (53) may be disposed between the first (52) and third (54) infrared wavelength ranges. In some instances, the third infrared wavelength range (54) may extend from about 1200 nm to about 1300 nm as shown in FIG. 4.

The normalized solar spectrum (80) may have an average relative intensity Si3 in the third infrared wavelength range (54) such that 0.05≤Si3≤Si2. For the incident light, the at least one polarization state, and the first incident angle range, the integral optical film may have an average optical transmittance Ti3 in the third infrared wavelength range (54). In some cases, Tv/Ti3≥2, or Tv/Ti3≥2.5, or Tv/Ti3≥3, or Tv/Ti3≥3.5, or Tv/Ti3≥4.

In some other embodiments, the normalized solar spectrum (80) may further include a fourth infrared wavelength range (55) that may be at least 50 nm wide and within 800-2500 nm. The third infrared wavelength range (54) may be disposed between the second (53) and fourth (55) infrared wavelength ranges. In some instances, the fourth infrared wavelength range (55) may extend from about 1500 nm to about 1750 nm as shown in FIG. 4.

The normalized solar spectrum (80) may have an average relative intensity Si4 in the fourth infrared wavelength range (55) such that 0.05≤Si4≤Si3. For the incident light, the at least one polarization state, and the first incident angle range, the integral optical film may have an average optical transmittance Ti4 in the fourth infrared wavelength range (55). In some case, Tv/Ti4≤2, or Tv/Ti4≤1.75, or Tv/Ti4≤1.5, or Tv/Ti4≤1.25, or Tv/Ti4≤1.1.

As seen in FIG. 4, the first (52), second (53), and third (54) infrared wavelength ranges are non-overlapping wavelength ranges that are within 800-2500 nm. Each of the first (52), second (53), and third (54) infrared wavelength ranges may have a width of at least 40 nm, or 45 nm, or 50 nm, or 55 nm, or 60 nm, or 70 nm, or 80 nm, or 90 nm, or 95 nm.

In some embodiments, the normalized solar spectrum (80) may have average relative intensities Sv, Si1, Si2 and Si3 in the respective visible (50) and the first through the third infrared wavelength ranges (52-54), such that Sv>Si1>Si2>Si3≥0.1. In some instances, Sv>Si1>Si2>Si3≥0.15. In some other instances, Sv>Si1>Si2>Si3≥0.2. In some other instances, Sv>Si1>Si2>Si3≥0.25.

In some embodiments, the integral optical film may have average optical transmittances Tv, Ti1, Ti2 and Ti3, in the respective visible (50) and the first through the third infrared wavelength ranges (52-54), such that each of Tv/Ti1 and Tv/Ti3 may be greater than 1.4, In some instances, each of Tv/Ti1 and Tv/Ti3 may be greater than 1.5, or greater than 1.75, or greater than 2, or greater than 2.25, or greater than 2.5, or greater than 2.75, or greater than 3, or greater than 3.25, or greater than 3.5. In some other instances, Tv/Ti2≤2.5, or Tv/Ti2≤2.25, or Tv/Ti2≤2, or Tv/Ti2≤1.75.

Table 3 shows the relative intensities of the normalized solar spectrum in the visible wavelength range (420 nm-680 nm), first infrared wavelength range (700 nm-950 nm), second infrared wavelength range (1000 nm-1100 nm), third infrared wavelength range (1200 nm-1300 nm), and fourth infrared wavelength range (1500 nm-1570 nm).

TABLE 3

| | |
|---|---|
| Sv (420-680) | 0.89 |
| Sil (700-950) | 0.57 |
| Si2 (1000-1100) | 0.39 |
| Si3 (1200-1300) | 0.26 |
| Si4 (1500-1750) | 0.14 |
| Sv/Sil | 1.57 |
| Sv/Si2 | 2.27 |
| Sv/Si3 | 3.40 |
| Sv/Si4 | 6.47 |

Table 4 shows the average optical transmittances of different optical film configurations (OF1, OF2 . . . OF9) at a first incident angle range extending from about 0°-85° in the visible wavelength range (420 nm-680 nm), first infrared wavelength range (700 nm-950 nm), second infrared wavelength range (1000 nm-1100 nm), third infrared wavelength range (1200 nm-1300 nm), and fourth infrared wavelength range (1500 nm-1570 nm).

TABLE 4

| | OF1 | OF2 | OF3 | OF4 | OF5 | OF6 | OF7 | OF8 | OF9 |
|---|---|---|---|---|---|---|---|---|---|
| Tv | 74.5 | 73.7 | 75.2 | 72.8 | 77.2 | 73.9 | 66.7 | 76.4 | 77.1 |
| (420-680) | | | | | | | | | |
| Ti1 | 44.5 | 43.7 | 47.1 | 20.1 | 44.0 | 46.2 | 60.0 | 28.4 | 42.6 |
| (700-950) | | | | | | | | | |
| Ti2 | 50.4 | 49.6 | 50.8 | 43.5 | 49.1 | 40.8 | 30.1 | 47.8 | 46.7 |
| (1000-1100) | | | | | | | | | |
| Ti3 | 18.0 | 13.6 | 17.9 | 17.8 | 11.4 | 21.3 | 10.0 | 17.9 | 17.9 |
| (1200-1300) | | | | | | | | | |
| Ti4 | 70.6 | 58.0 | 70.6 | 69.5 | 44.6 | 69.8 | 5.2 | 71.8 | 41.7 |
| (1500-1750) | | | | | | | | | |
| Tv/Ti1 | 1.7 | 1.7 | 1.6 | 3.6 | 1.8 | 1.6 | 1.1 | 2.7 | 1.8 |
| Tv/Ti2 | 1.5 | 1.5 | 1.5 | 1.7 | 1.6 | 1.8 | 2.2 | 1.6 | 1.6 |
| Tv/Ti3 | 4.1 | 5.4 | 4.2 | 4.1 | 6.8 | 3.5 | 6.7 | 4.3 | 4.3 |
| Tv/Ti4 | 1.1 | 1.3 | 1.1 | 1.0 | 1.7 | 1.1 | 12.7 | 1.1 | 1.8 |

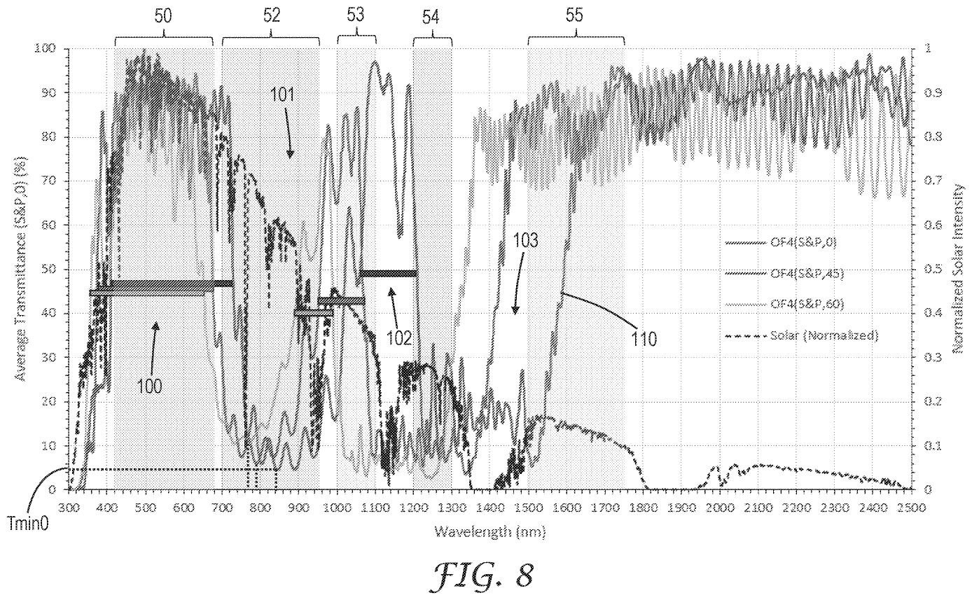

FIG. 8 shows the average optical transmittance of an integral optical film according to one or more embodiments of the disclosure conflated with the solar intensity of the normalized solar spectrum. The illustrated embodiment shows an optical transmittance (110) of the integral optical film versus wavelength for an incident light (40, FIG. 1) incident on the integral optical film at a first incident angle of less than about 10 degrees, or less than about 8 degrees, or less than about 6 degrees, or less than about 4 degrees, or less than about 3 degrees, or less than about 2 degrees, or less than about 1 degree and for at least one polarization state (x- & y-axes).

The optical transmittance (110) includes a first transmission band (100) and a second transmission band (102). The optical transmittance (100) further includes a first transmission stop band (101) and a second infrared transmission stop band (103). The first transmission stop band (101) is disposed between the first transmission band (100) and the second transmission band (102) and the second infrared transmission stop band (103) is disposed adjacent the second transmission band (102) opposite the first transmission stop band (101).

The first transmission band (100) may include at least a majority of wavelengths in a visible wavelength range (50) extending from about 420 nm to about 680 nm. The first transmission stop band (101) may include at least a majority of wavelengths in a first infrared wavelength range (52) extending from about 700 nm to about 950 nm. The second infrared transmission stop band (103) may include at least some wavelengths in a second infrared wavelength range (54) extending from about 1200 nm to about 1300 nm.

In some embodiments, for the visible wavelength range (50), the integral optical film may have an average optical transmission, Tv, for the first incident angle. For the second infrared wavelength range (54), the integral optical film may have an average optical transmission, Ti, for the first incident angle.

For a second incident angle of greater than about 30 degrees, or 35 degrees, or 40 degrees, or 45 degrees, or 50 degrees, or 55 degrees, or 60 degrees, the integral optical film may have average optical transmissions Tv′ and Ti′ for visible (50) and second infrared (54) wavelength ranges respectively.

In some cases, Tv and Tv′ may be within 30% of each other. In some other cases, Tv and Tv′ may be within 25%, or 20%, or 15%, or 10% of each other.

In some cases, Ti may be greater than Ti′ by at least a factor of 1.3. In some other cases, Ti may be greater than Ti′ by at least a factor of 1.4, or 1.5, or 1.6, or 1.7, or 1.8, or 1.9, or 2, or 2.1, or 2.2, or 2.3, or 2.4, or 2.5.

Table 5 shows the average optical transmittances of an optical film according to an embodiment at incident angles 0° and 45° in the visible wavelength range and infrared wavelength ranges.

TABLE 5
Optical Transmittance of Integral Optical

| | Optical Transmittance of | |
|---|---|---|
| | Film (OF4) | |
| | At 0 degrees | At 45 degrees |
| | (incident angle) | (incident angle) |
| Tv (420 nm-680 nm) | 86.6 (Tv) | 82.3 (Tv′) |
| Ti1 (700 nm-950 nm) | 20.8 | 16.2 |
| Ti2 (1000 nm-1100 nm) | 59.7 | 57.7 |
| Ti3 (1200 nm-1300 nm) | 23.2 (Ti) | 9.4 (Ti′) |
| Ti4 (1500 nm-1750 nm) | 58.8 | 85.4 |
| [(Tv(0)-Tv(45))/Tv(0)] * 100 | 5.0 | |
| [(Ti1(0)-Til(45))/Ti1(0)] * 100 | 22.2 | |
| [(Ti2(0)-Ti2(45))/Ti2(0)] * 100 | 3.4 | |
| [(Ti3(0)-Ti3(45))/Ti3(0)] * 100 | 59.4 | |
| [(Ti4(0)-Ti4(45))/Ti4(0)] * 100 | −45.2 | |
| Tv(0)/Tv(45) | 1.1 | |
| Ti1(0)/Ti1(45) | 1.3 | |
| Ti2(0)/Ti2(45) | 1.0 | |
| Ti3(0)/Ti3(45) | 2.5 | |
| Ti4(0)/Ti4(45) | 0.7 | |

Table 6 shows different optical film designs and their respective optical transmittances at visible wavelengths (average of 380-780 nm, normal incidence) and LiDAR operational wavelengths (average over 45-75° at 905 nm), and solar rejection performances (weighted reflection summed over wavelength of R times solar intensity).

TABLE 6

| | Stack 1 (<905 nm) | | | Stack 2 (>905 nm) | | | | | |
|---|---|---|---|---|---|---|---|---|---|
| | | | # of | | | # of | T | T | R |
| Design | Stack type | Material | layers | Stack type | Material | layers | LiDAR | Visible | Solar |
| 1 | MOF-AB | HIO-PET | 112 | MOF- | A-PET | 425 | 71.70 | 82.49 | 29.29 |
| | | LIO- | | ACBC | B-CoPMMA | | | | |
| | | CoPMMA | | | C-PETg | | | | |
| 2 | MOF-AB | HIO-PET | 112 | MOF- | A-PET | 224 | 68.85 | 83.55 | 31.07 |
| | | LIO- | | ACBC | B-THV | | | | |
| | | CoPMMA | | | C-CoPMMA | | | | |
| 3 | MOF-ACBC | A-PET | 224 | MOF- | A-PET | 425 | 75.30 | 82.25 | 28.51 |
| | | B-CoPMMA | | ACBC | B-CoPMMA | | | | |
| | | C-PETg | | | C-PETg | | | | |
| 4 | Inorganic- | HIO-Nb2O5 | 10 | MOF- | A-PET | 425 | 41.48 | 73.95 | 40.61 |
| | AB | LIO-Acrylate | | ACBC | B-CoPMMA | | | | |
| | | | | | C-PETg | | | | |
| 5 | MOF-AB | HIO-PET | 112 | MOF-711 | HIO-PET | 650 | 68.89 | 89.16 | 29.93 |
| | | LIO- | | | LIO- | | | | |
| | | CoPMMA | | | CoPMMA | | | | |
| 6 | MOF-ACBC Fabry-Perot with 11 cavities | | | | | | 59.74 | 80.44 | 29.55 |
| 7 | Ag/ITO/Ag stack 7 layers | | | | | | 52.08 | 75.49 | 28.50 |
| 8 | Inorganic- | HIO-SiON | 20 | MOF- | A-PET | 425 | 63.61 | 82.64 | 35.16 |
| | AB | LIO-Acrylate | | ACBC | B-CoPMMA | | | | |
| | | | | | C-PETg | | | | |
| 9 | MOF-AB | HIO-PET | 112 | Inorganic- | HIO-TiO2 | 40 | 64.80 | 88.56 | 31.74 |
| | | LIO- | | 711 | LIO-Acrylate | | | | |
| | | CoPMMA | | | | | | | |

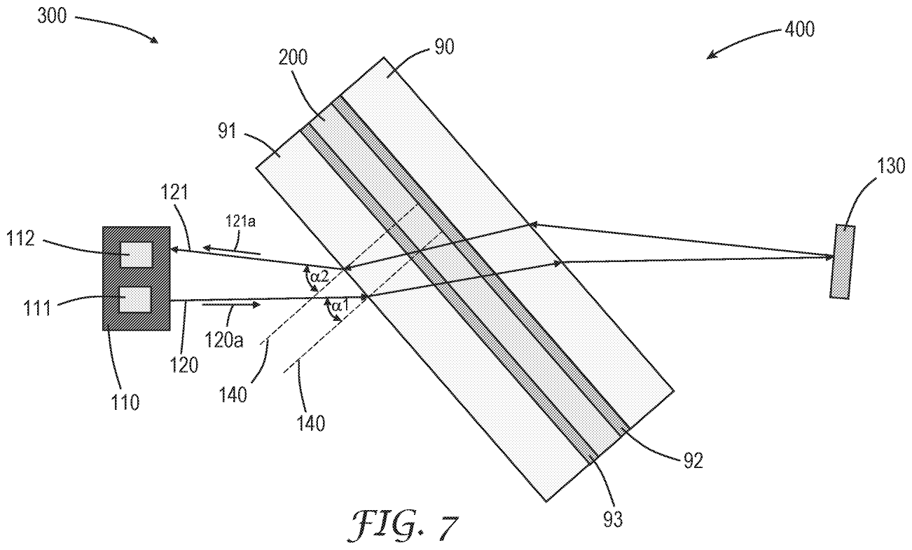

FIG. 7 shows an optical sensing system (400) that includes a windshield (300) having the integral optical film (200) of one or more embodiments of the disclosure disposed between first (90) and second (91) substrates. The first (90) and second (91) substrates, in some cases, may be IR clear glass. The optical film (200 may be bonded to first (90) and second (91) substrates via respective first (92) and second (93) bonding layers. In the visible wavelength range, the windshield (300) may be transparent and color-free.

The optical sensing system (400) includes a transceiver (110) having at least one of a transmitter (111) and a receiver (112). In some cases, the transceiver (110) may include at least one transmitter (111) and at least one receiver (112). In some aspects, the transmitter (111) may include a laser light source. The receiver (112) may include an optical detector and, in some cases, the receiver (1120 may include a camera. The transceiver (110), in some embodiments, may be a LiDAR transceiver.

The transceiver (110) may be configured to emit (120) and/or receive (121) a first light toward an object (130) through the windshield (300). The emitted first light may have a wavelength between about 850 nm to about 950 nm, or about 900 nm to about 950 nm. In some cases, the emitted first light may have a wavelength between about 1400 nm to about 1700 nm, or about 1500 nm to about 1600 nm. The emitted first light may include a pulsed laser light or a continuous laser light. In some cases, the continuous laser light may be at least one of phase and frequency modulated.

The transceiver (110) may be disposed in an interior cabin of the vehicle so that the integral optical film (200) can be disposed between the transceiver (110) and an exterior surface of the windshield (300). In one aspect, the transceiver (110) may be disposed on or proximate an interior rear-view mirror of the vehicle. For example, the transceiver (110) may be a LiDAR transceiver disposed behind the rear view mirror.

In the LiDAR spectrum, the windshield (300) may allow the first light to pass through at a designed angular range. For instance, the first light may be emitted or received along a propagation direction (120a, 121a). The first light emitted or received along a propagation direction (120a, 121a) makes a first angle (α1, α2) in air with a normal (140) to the windshield (300). In some cases, the first angle (α1, α2) may be greater than about 20 degrees, or greater than about 25 degrees, or greater than about 30 degrees, or greater than about 35 degrees, or greater than about 40 degrees, or greater than about 45 degrees, or greater than about 50 degrees, or greater than about 55 degrees, or greater than about 60 degrees, or greater than about 65 degrees. In the rest of the solar spectrum, the windshield (300) reflects or absorbs the incident light to maintain thermal comfort for the cabin as well as the LiDAR system compartment behind the windshield (300).

Descriptions for elements in figures should be understood to apply equally to corresponding elements in other figures, unless indicated otherwise. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations, or variations, or combinations of the specific embodiments discussed herein. Therefore, it is intended that this disclosure be limited only by the claims and the equivalents thereof.

1-15. (canceled)

16. An optical construction comprising:
a windshield of an automobile, the windshield comprising an integral optical film disposed between and bonded to first and second substrates, the integral optical film having an integral construction and comprising a plurality of first optical repeat units numbering at least 10 in total disposed on, and separated by at least one spacer layer from, a plurality of second optical repeat units numbering at least 10 in total, each of the first optical repeat units having at least microlayers A1 and B1 having different compositions, each of the second optical repeat units having at least microlayers A2, B2 and C2 having different compositions, at least one of the microlayers A1 and B2 having a different composition than at least one of the microlayers A2, B2 and C2, each of the microlayers in the first and second optical repeat units having an average thickness of less than about 500 nm, each of the at least one spacer layer having an average thickness of greater than about 500 nm, such that for an incident light, for at least one polarization state, a visible wavelength range extending from about 420 nm to about 680 nm, an infrared wavelength range that is at least 10 nm wide and is within 750-1000 nm, a first incident angle range extending from about zero degree to about 20 degrees, and a second incident angle range extending from about 45 degrees to about 75 degrees, the integral optical film has:
for the visible wavelength range, an average optical transmittance of greater than about 45% for each of the first and second incident angle ranges; and
for the infrared wavelength range, an average optical transmittance of less than about 20% for the first incident angle range and an average optical transmittance of greater than about 45% for the second incident angle range.

17. The optical construction of claim 16, wherein each of the first and second substrates comprises glass.

18. An optical sensing system comprising:
the optical construction of claim 16; and
a transceiver comprising at least one of a transmitter and a receiver and configured to at least one of emit and receive a first light toward an object through the windshield along a propagation direction making a first angle in air with a normal to the windshield, the first angle greater than about 20 degrees.

19. The optical sensing system of claim 18, wherein the transceiver comprises at least one transmitter and at least one receiver.

20. The optical sensing system of claim 18, wherein the transmitter comprises a laser light source and the receiver comprises an optical detector.

21. An optical construction comprising:
a windshield of an automobile, the windshield comprising an integral optical film disposed between and bonded to first and second glass substrates, the integral optical film comprising a plurality of at least first through third microlayers having different compositions and numbering at least 20 in total, each of the at least first through third microlayers having an average thickness of less than about 500 nm,
such that for an incident light, for at least one polarization state, a first incident angle range extending from about zero degree to at least about 40 degrees, and a normalized solar spectrum with an air mass of 1.5 and normalized across a solar wavelength range that comprises at least a visible wavelength extending from about 420 nm to about 680 nm and a first infrared wavelength range that is at least 50 nm wide and is within 800-2500 nm, the normalized solar spectrum has average relative intensities Sv and Si1 in the respective visible and first infrared wavelength ranges and the integral optical film has average optical transmittances Tv and Ti1 in the respective visible and first infrared wavelength ranges, Sv>Si1≥0.2, Tv/Ti1≥1.4.

22. The optical construction of claim 21, wherein 1≤Sv/Si1≤2.

23. The optical construction of claim 21, wherein the normalized solar spectrum further comprises a second infrared wavelength range that is at least 50 nm wide and is within 800-2500 nm, the first infrared wavelength range disposed between the visible and second infrared wavelength ranges, wherein the normalized solar spectrum has an average relative intensity Si2 in the second infrared wavelength range, Si2≤Si1, such that for the incident light, the at least one polarization state, and the first incident angle range, the integral optical film has an average optical transmittance Ti2 in the second infrared wavelength range, Tv/Ti2≤2.5.

24. The optical construction of claim 23, wherein the normalized solar spectrum further comprises a third infrared wavelength range that is at least 50 nm wide and is within 800-2500 nm, the second infrared wavelength range disposed between the first and third infrared wavelength ranges, wherein the normalized solar spectrum has an average relative intensity Si3 in the third infrared wavelength range, 0.05≤Si3≤Si2, such that for the incident light, the at least one polarization state, and the first incident angle range, the integral optical film has an average optical transmittance Ti3 in the third infrared wavelength range, Tv/Ti3≥2.

25. The optical construction of claim 24, wherein the normalized solar spectrum further comprises a fourth infrared wavelength range that is at least 50 nm wide and is within 800-2500 nm, the third infrared wavelength range disposed between the second and fourth infrared wavelength ranges, wherein the normalized solar spectrum has an average relative intensity Si4 in the fourth infrared wavelength range, 0.05≤Si4≤Si3, such that for the incident light, the at least one polarization state, and the first incident angle range, the integral optical film has an average optical transmittance Ti4 in the fourth infrared wavelength range, Tv/Ti4≤2.

26. The optical construction of claim 21, wherein each of the first and second substrates comprises infrared transparent glass.

27. An optical sensing system comprising:
the optical construction of claim 21; and
a transceiver comprising at least one of a transmitter and a receiver and configured to at least one of emit and receive a first light toward an object through the windshield along a propagation direction making a first angle in air with a normal to the windshield, the first angle greater than about 20 degrees.

28. An optical construction comprising:
a windshield of an automobile, the windshield comprising an integral optical film disposed between and bonded to first and second glass substrates, the integral optical film comprising a plurality of at least first through third microlayers having different compositions and numbering at least 20 in total, each of the at least first through third microlayers having an average thickness of less than about 500 nm,
such that for an incident light, for at least one polarization state, a first incident angle range extending from about zero degree to at least about 40 degrees, and a normalized solar spectrum with an air mass of 1.5 and normalized across a solar wavelength range that comprises a visible wavelength range extending from about 420 nm to about 680 nm and at least non-overlapping first, second and third infrared wavelength ranges that are within 800-2500 nm, have respective average relative intensities Si1, Si2 and Si3, and are at least 40 nm wide each, the normalized solar spectrum and the integral optical film have respective average relative intensities Sv, Si1, Si2 and Si3 and average optical transmittances Tv, Ti1, Ti2 and Ti3 in the respective visible and the first through the third infrared wavelength ranges, Sv>Si1>Si2>Si3≥0.1, each of Tv/Ti1 and Tv/Ti3 greater than 1.4, Tv/Ti2≤2.5.

29. The optical construction of claim 28, wherein the plurality of the at least first through third microlayers comprises a plurality of alternating microlayers A1 and B1 numbering at least 5 in total disposed on a plurality of alternating microlayers A2, C2, B2 and C2 numbering at least 10 in total, the microlayers A1 and B1 having different compositions, the microlayers A2, B2 and C2 having different compositions, at least one of the microlayers A1 and B1 having a different composition than at least one of the microlayers A2, B2 and C2, each of the microlayers A1, B1, A2, B2 and C2 having an average thickness of less than about 500 nm.

30. The optical construction of claim 28, wherein the plurality of the at least first through third microlayers comprises a plurality of alternating microlayers A1, C1, B1 and C1 numbering at least 50 in total disposed on a plurality of alternating microlayers A2, C2, B2 and C2 numbering at least at least 200 in total, the microlayers A1, B1 and C1 having different compositions, the microlayers A2, B2 and C2 having different compositions, at least one of the microlayer A1, B1 and C1 having a different composition than at least one of the microlayers A2, B2 and C2, each of the microlayers A1, B1, C1, A2, B2 and C2 having an average thickness of less than about 500 nm.

31. The optical construction of claim 28, wherein the plurality of the at least first through third microlayers comprises a plurality of alternating microlayers A1 and B1 numbering at least 50 in total disposed on a plurality of alternating microlayers A2, B3, A3, B2, A3 and B3 numbering at least 100 in total, the microlayers A1 and B1 having different compositions, the microlayers A2 and A3 having substantially a same composition and different thicknesses, the microlayers B2 and B3 having substantially a same composition and different thicknesses, at least one of the microlayer A1 and B1 having a different composition than at least one of the microlayers A2 and B2, each of the microlayers A1, B1, A2, B2, A3, B3 having an average thickness of less than about 500 nm.

32. The optical construction of claim 31, wherein at least most of the microlayers A1 are thinner than at least most of the microlayers B2, and at least most of the microlayers B1 are thicker than at least most of the microlayers A3 and B3.

33. The optical construction of claim 28, wherein each of the first and second substrates comprises infrared transparent glass.

34. An optical sensing system comprising:
the optical construction of claim 28; and
a transceiver comprising at least one of a transmitter and a receiver and configured to at least one of emit and receive a first light toward an object through the windshield along a propagation direction making a first angle in air with a normal to the windshield, the first angle greater than about 20 degrees.
